(19) United States
(12) Patent Application Publication
(10) Pub. No.: US 2024/0040279 A1
(43) Pub. Date: Feb. 1, 2024

(54) PHOTOELECTRIC CONVERSION DEVICE AND METHOD OF DRIVING PHOTOELECTRIC CONVERSION DEVICE

(71) Applicant: CANON KABUSHIKI KAISHA, Tokyo (JP)

(72) Inventors: YU ARISHIMA, Kanagawa (JP); KOICHIRO IWATA, Kanagawa (JP); MASAKI SATO, Kanagawa (JP); SHINYA ICHINO, Tokyo (JP)

(21) Appl. No.: 18/355,599

(22) Filed: Jul. 20, 2023

(30) Foreign Application Priority Data
Jul. 29, 2022 (JP) 2022-121644

(51) Int. Cl. H04N 25/766; H04N 25/77; H04N 25/40; H04N 25/703

(52) U.S. Cl. CPC H04N 25/766; H04N 25/77; H04N 25/40; H04N 25/703

(57) ABSTRACT

The photoelectric conversion device includes a plurality of pixels arranged to form a plurality of rows and a plurality of columns, wherein each of the plurality of pixels includes a photoelectric conversion unit, a plurality of output lines, wherein at least two of the plurality of output lines are arranged in each of the plurality of columns and each of the plurality of output lines is connected to a pixel of a corresponding column, a scanning circuit configured to sequentially select plural rows that are a part of the plurality of rows, and a selection circuit that includes an input unit to which a control signal different from a control signal input to the scanning circuit is input and is configured to select a row that is the other part of the plurality of rows.

### BACKGROUND OF THE INVENTION

### Field of the Invention

The present invention relates to a photoelectric conversion device and a method of driving a photoelectric conversion device.

### Description of the Related Art

There is known a photoelectric conversion device in which a plurality of output lines is arranged in each column of a pixel region, and pixel signals of a plurality of pixel rows are simultaneously read out from the plurality of output lines to thereby read out pixel signals at high speed. In such a photoelectric conversion device, amounts of signals to be read out changes due to potential variation between the output lines, and image quality may deteriorate. International Publication No. WO2015/151793 describes an imaging device configured to suppress potential variation between output lines by fixing an output line to a predetermined potential before reading out a pixel reset signal, and to prevent amounts of signals to be read out from the output lines from being different.

However, in the imaging device described in International Publication No. WO2015/151793, the potential variation between the output lines may not be sufficiently suppressed depending on a driving mode.

### SUMMARY OF THE INVENTION

An object of the present invention is to provide a photoelectric conversion device and a method of driving method the same capable of effectively suppressing potential variation between output lines depending on a driving mode.

According to an embodiment of the present disclosure, there is provided a photoelectric conversion device including a plurality of pixels arranged to form a plurality of rows and a plurality of columns, each of the plurality of pixels including a photoelectric conversion unit, a plurality of output lines, at least two of the plurality of output lines being arranged in each of the plurality of columns, each of the plurality of output lines being connected to a pixel of a corresponding column, a scanning circuit configured to sequentially select plural rows that are a part of the plurality of rows, and a selection circuit that includes an input unit to which a control signal different from a control signal input to the scanning circuit is input and is configured to select a row that is the other part of the plurality of rows.

According to another embodiment of the present disclosure, there is provided a method of driving a photoelectric conversion device including a plurality of pixels arranged to form a plurality of rows and a plurality of columns, wherein each of the plurality of pixels includes a photoelectric conversion unit, a plurality of output lines, wherein at least two of the plurality of output lines are arranged in each of the plurality of columns and each of the plurality of output lines is connected to a pixel of a corresponding column, a scanning circuit configured to sequentially select plural rows that are a part of the plurality of rows, and a selection circuit configured to select a row that is the other part of the plurality of rows, the method including selecting a first row among the part of the plurality rows by the scanning circuit, and selecting, in a period of outputting a signal of a first pixel of the first row to a first output line among the plurality of output lines, a second row among the other part of the plurality of rows to output a signal of a second pixel of the second row to a second output line arranged in a same column as the first output line.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a photoelectric conversion device according to a first embodiment of the present invention.

FIG. 2 is an equivalent circuit diagram illustrating a configuration example of a unit pixel in the photoelectric conversion device according to the first embodiment of the present invention.

FIG. 3 is an equivalent circuit diagram illustrating a configuration example of a null pixel in the photoelectric conversion device according to the first embodiment of the present invention.

FIG. 4 is a schematic diagram illustrating a connection example of the unit pixels and the null pixels in the photoelectric conversion device according to the first embodiment of the present invention.

FIG. 5 is a block diagram illustrating a configuration example of a vertical driving circuit in the photoelectric conversion device according to the first embodiment of the present invention.

FIG. 6 is a circuit diagram illustrating a configuration example of a control circuit in the photoelectric conversion device according to the first embodiment of the present invention.

FIG. 7 is a timing chart illustrating an operation of a control circuit in the photoelectric conversion device according to the first embodiment of the present invention.

FIG. 8 and FIG. 9 are timing charts illustrating a driving example of the photoelectric conversion device according to the first embodiment of the present invention.

FIG. 10 is a block diagram illustrating a configuration example of a vertical driving circuit in a photoelectric conversion device according to a second embodiment of the present invention.

FIG. 11 is a block diagram illustrating a schematic configuration of an imaging system according to a third embodiment of the present invention.

FIG. 12A is a diagram illustrating a configuration example of an imaging system according to a fourth embodiment of the present invention.

FIG. 12B is a diagram illustrating a configuration example of a movable object according to the fourth embodiment of the present invention.

FIG. 13 is a block diagram illustrating a schematic configuration of equipment according to a fifth embodiment of the present invention.

### DESCRIPTION OF THE EMBODIMENTS

Preferred embodiments of the present invention will now be described in detail in accordance with the accompanying drawings.

### First Embodiment

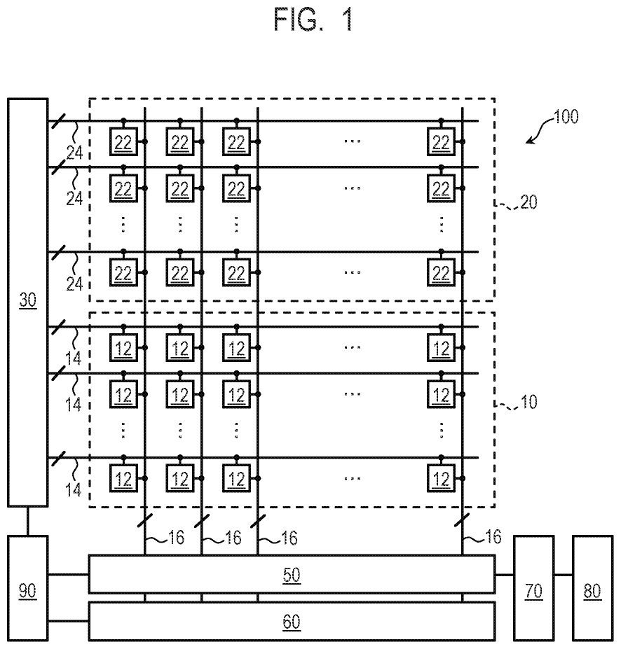

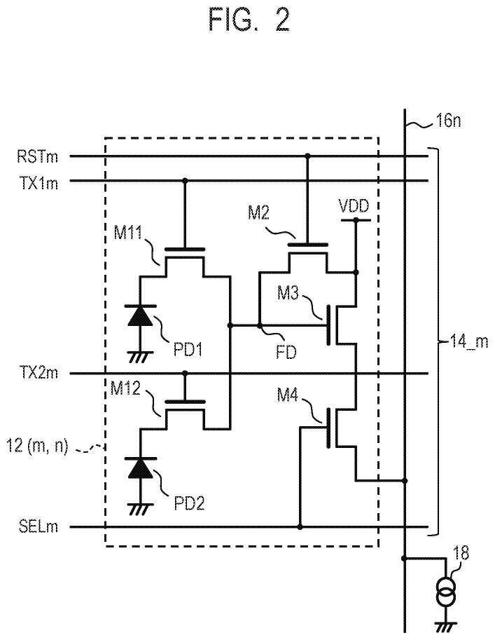

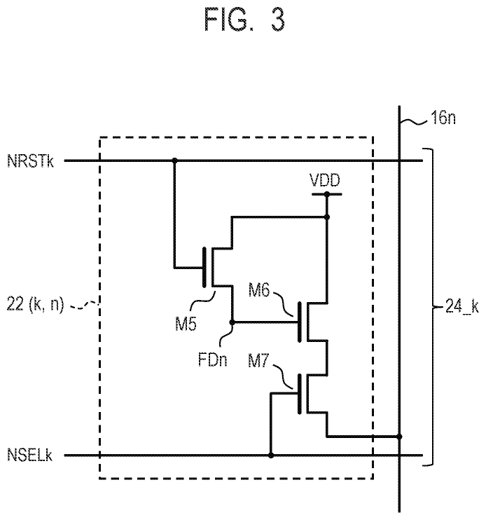

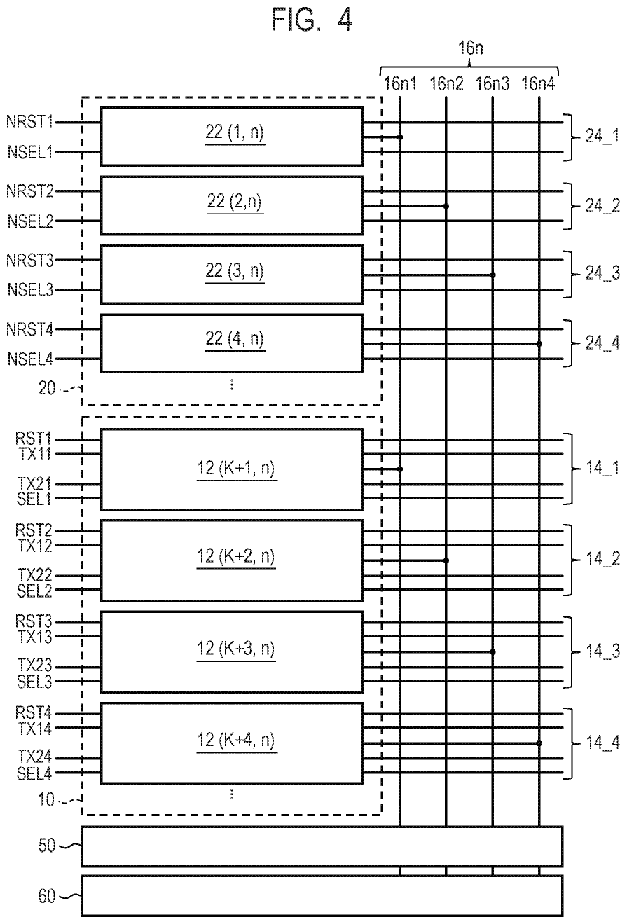

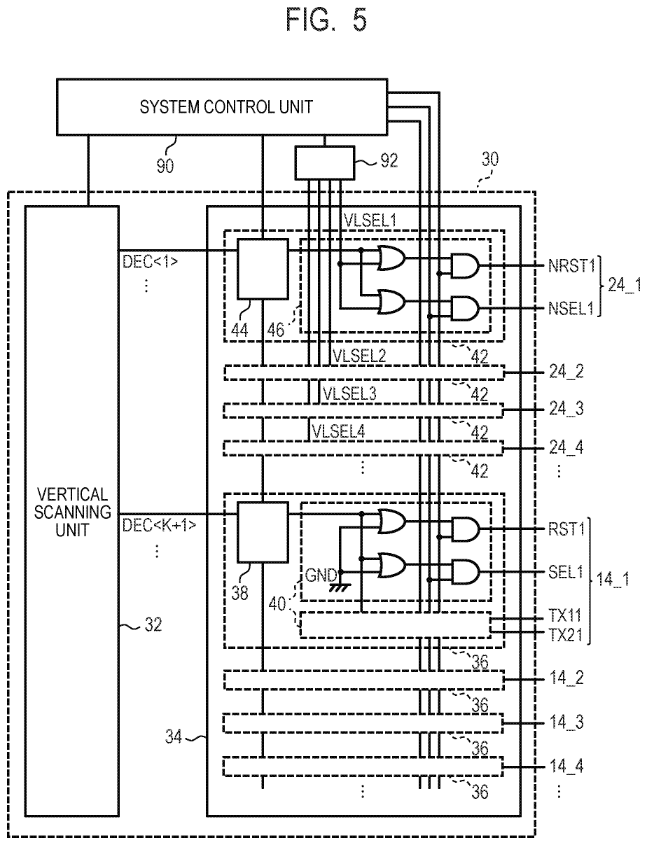

A photoelectric conversion device according to a first embodiment of the present invention will be described with reference to FIG. 1 to FIG. 5. FIG. 1 is a block diagram illustrating a schematic configuration of a photoelectric conversion device according to the present embodiment. FIG. 2 is an equivalent circuit diagram illustrating a configuration example of a unit pixel in the photoelectric conversion device according to the present embodiment. FIG. 3 is an equivalent circuit diagram illustrating a configuration example of a null pixel in the photoelectric conversion device according to the present embodiment. FIG. 4 is a schematic diagram illustrating a connection example of the unit pixels and the null pixels in the photoelectric conversion device according to the present embodiment. FIG. 5 is a block diagram illustrating a configuration example of a vertical driving circuit in the photoelectric conversion device according to the present embodiment.

As illustrated in FIG. 1, the photoelectric conversion device 100 according to the present embodiment includes pixel regions 10 and 20, a vertical driving circuit 30, a column circuit unit 50, a horizontal driving circuit 60, a signal processing unit 70, an output circuit 80, and a system control unit 90.

In the pixel region 10, a plurality of unit pixels 12 arranged in a matrix form over a plurality of rows and a plurality of columns are provided. Each of the plurality of unit pixels 12 includes a photoelectric conversion unit including a photoelectric conversion element such as a photodiode, and outputs a pixel signal corresponding to an amount of incident light. In addition, in the pixel region 10, in addition to effective pixels which output the pixel signals according to the amount of incident light, optical black pixels in which the photoelectric conversion units are shielded from light, dummy pixels which do not output signals, and the like may be arranged.

In the pixel region 20, a plurality of null pixels 22 arranged in a matrix form over a plurality of rows and a plurality of columns are provided. Each of the plurality of null pixels 22 is a reference pixel that does not include a photoelectric conversion unit and outputs a predetermined pixel signal corresponding to a given voltage.

The plurality of null pixels 22 constituting the pixel region 20 are arranged in different rows in the same columns as the columns in which the plurality of unit pixels 12 constituting the pixel region 10 are arranged. For example, a plurality of unit pixels 12 arranged in a matrix of M rows×N columns may be arranged in the pixel region 10, and a plurality of null pixels 22 arranged in a matrix of K rows×N columns may be arranged in the pixel region 20. In this case, assuming that the first row of the pixel region is the first row, N-number of null pixels 22 may be arranged in each of the first to K-th rows, and N-number of unit pixels 12 may be arranged in each of the (K+1)-th to (K+M)-th rows. In each of the first to N-th columns, K-number of null pixels 22 and M-number of unit pixels 12 may be arranged. The number of rows and the number of columns of the pixel array arranged in the pixel regions 10 and 20 are not particularly limited.

In each row of the pixel region 10, a control line 14 is arranged so as to extend in the first direction (lateral direction in FIG. 1). The control line 14 in each row is connected to each of the unit pixels 12 on the corresponding row arranged in the first direction, and serves as a signal line common to these unit pixels 12. In addition, in each row of the pixel region 20, a control lines 24 is arranged so as to extend in the first direction. The control line 24 in each row is connected to each of the null pixels 22 on the corresponding row arranged in the first direction, and serves as a signal line common to these null pixels 22. The first direction in which the control lines 14, 24 extend may be referred to as a row direction or a horizontal direction. Each of the control lines 14, 24 may include a plurality of signal lines. The control lines 14 and 24 are connected to the vertical driving circuit 30.

In each column of the pixel regions 10 and 20, a vertical output line 16 is arranged so as to extend in a second direction (vertical direction in FIG. 1) intersecting with the first direction. The vertical output line 16 in each column is connected to the unit pixels 12 and the null pixels 22 on the corresponding column arranged in the second direction, and serves as a signal line common to these unit pixels 12 and null pixels 22. The second direction in which the vertical output lines 16 extend may be referred to as a column direction or a vertical direction. Each of the vertical output lines 16 includes a plurality of output lines. The vertical output lines 16 are connected to the column circuit unit 50. A specific connection relationship between the unit pixels 12 and the null pixels 22, and the vertical output lines 16 will be described later.

The vertical driving circuit 30 is a control circuit having a function of receiving control signals supplied from the system control unit 90, generating control signals for driving the unit pixel 12 and the null pixel 22, and supplying the generated control signals to the unit pixel 12 and the null pixel 22 via the control lines 14 and 24. A logic circuit such as a shift register or an address decoder may be used as the vertical driving circuit 30. The vertical driving circuit 30 sequentially supplies the control signals to the control lines 14 and 24 in each row, and sequentially drives the unit pixels 12 in the pixel region 10 and the null pixels 22 in the pixel region 20 in units of rows. The signals read out from the unit pixels 12 and the null pixels 22 in units of rows are input to the column circuit unit 50 via the vertical output lines 16 provided in the respective columns of the pixel regions 10 and 20.

The column circuit unit 50 includes a plurality of column circuits that is provided corresponding to each of the plurality of output lines constituting the vertical output lines 16 of each column of the pixel regions 10 and 20 and each includes a processing circuit and a signal holding circuit. The processing circuit has a function of performing predetermined signal processing on the pixel signal output via the corresponding output line. Examples of the signal processing performed by the processing circuit include amplification processing, correction processing by correlated double sampling (CDS), and analog-to-digital conversion (AD conversion) processing. The signal holding circuit functions as a memory for holding the pixel signal processed by the processing circuit.

The horizontal driving circuit 60 is a control circuit having a function of receiving control signals supplied from the system control unit 90, generating control signals for reading out the pixel signals from the column circuit unit 50, and supplying the generated control signals to the column circuit unit 50. The horizontal driving circuit 60 sequentially scans the column circuits of the respective columns of the column circuit unit 50, and sequentially outputs the pixel signals held in the respective columns to the signal processing unit 70. A logic circuit such as a shift register or an address decoder may be used as the horizontal driving circuit 60.

The signal processing unit 70 has a function of performing predetermined signal processing on the pixel signals transferred from the column circuit unit 50. Examples of the processing executed by the signal processing unit 70 include arithmetic processing, amplification processing, and correction processing using CDS.

The output circuit 80 includes an external interface circuit, and outputs the signals processed by the signal processing unit 70 to the outside of the photoelectric conversion device 100. The external interface circuit included in the output circuit 80 is not particularly limited. For example, SerDes (SERializer/DESerializer) transmission circuits such as LVDS (Low Voltage Differential Signaling) circuit and SLVS (Scalable Low Voltage Signaling) circuit may be applied to the external interface circuit.

The system control unit 90 is a control circuit that generates control signals for controlling operations of the vertical driving circuit 30, the column circuit unit 50, the horizontal driving circuit 60, and the like, and supplies the generated control signals to the respective functional blocks. Note that the control signals for controlling the operations of the vertical driving circuit 30, the column circuit unit 50, the horizontal driving circuit 60, and the like are not necessarily supplied from the system control unit 90, and at least a part of them may be supplied from the outside of the photoelectric conversion device 100.

Next, a configuration example of the unit pixel 12 in the photoelectric conversion device according to the present embodiment will be described with reference to FIG. 2. FIG. 2 illustrates a unit pixel 12(m, n) arranged in the m-th row and the n-th column among the plurality of unit pixels 12 constituting the pixel region 10. Here, m is an integer of 1 to M, and n is an integer of 1 to N. The circuit configuration of the other unit pixels 12 constituting the pixel region 10 may be similar to that of the unit pixel 12(m, n).

For example, as illustrated in FIG. 2, the unit pixel 12(m, n) may be composed of photoelectric conversion elements PD1 and PD2, transfer transistors M11 and M12, a reset transistor M2, an amplifier transistor M3, and a select transistor M4. The unit pixel 12(m, n) may include a microlens and a color filter arranged on the optical path until the incident light is guided to the photoelectric conversion elements PD1 and PD2. The microlens collects incident light on the photoelectric conversion elements PD1 and PD2. The color filter selectively transmits light of a predetermined color.

The photoelectric conversion elements PD1 and PD2 are, for example, photodiodes. The photoelectric conversion element PD1 has an anode connected to a ground voltage node and a cathode connected to a source of the transfer transistor M11. The photoelectric conversion element PD2 has an anode connected to the ground voltage node and a cathode connected to a source of the transfer transistor M12. A drain of the transfer transistor M11 and a drain of the transfer transistor M12 are connected to a source of the reset transistor M2 and a gate of the amplifier transistor M3. A node FD to which the drain of the transfer transistor M11, the drain of the transfer transistor M12, the source of the reset transistor M2, and the gate of the amplifier transistor M3 are connected is a so-called floating diffusion. The floating diffusion includes a capacitance component (floating diffusion capacitance) and functions as a charge holding portion. The floating diffusion capacitance may include a p-n junction capacitance and an interconnection capacitance. A drain of the reset transistor M2 and a drain of the amplifier transistor M3 are connected to a node to which a power supply voltage (voltage VDD) is supplied. A source of the amplifier transistor M3 is connected to a drain of the select transistor M4. A source of the select transistor M4 is connected to the vertical output line 16n. A current source 18 is connected to the vertical output line 16n.

In the circuit configuration of FIG. 2, the control line 14_m of the m-th row includes four signal lines including a signal line connected to a gate of the transfer transistor M11, a signal line connected to a gate of the transfer transistor M12, a signal line connected to a gate of the reset transistor M2, and a signal line connected to a gate of the select transistor M4. A control signal TX1m is supplied from the vertical driving circuit 30 to the gates of the transfer transistors M11 of the unit pixels 12 of the m-th row. A control signal TX2m is supplied from the vertical driving circuit 30 to the gates of the transfer transistors M12 of the unit pixels 12 of the m-th row. A control signal RSTm is supplied from the vertical driving circuit 30 to the gates of the reset transistors M2 of the unit pixels 12 of the m-th row. A control signal SELm is supplied from the vertical driving circuit 30 to the gates of the select transistors M4 of the unit pixels 12 of the m-th row. In a case that each transistor is formed of an n-channel MOS transistor, when a high-level control signal is supplied from the vertical driving circuit 30, the corresponding transistor is turned on. When a low-level control signal is supplied from the vertical driving circuit 30, the corresponding transistor is turned off.

In the present embodiment, a description will be given assuming a case where electrons among electron-hole pairs generated in the photoelectric conversion elements PD1 and PD2 by light incidence are used as signal charge. When electrons are used as the signal charge, each transistor constituting the unit pixel 12 may be formed of an n-channel MOS transistor. However, the signal charge is not limited to electrons, and holes may be used as the signal charge. When holes are used as the signal charge, the conductivity type of each transistor is opposite to that described in the present embodiment. Note that the term “source” or “drain” of the MOS transistor may vary depending on the conductivity type of the transistor and/or the target function. Some or all of names of a source and a drain used in the present embodiment are sometimes referred to as reverse names.

The photoelectric conversion elements PD1 and PD2 convert (photoelectrically convert) incident light into charge of an amount corresponding to an amount of the incident light, and accumulate the generated charge. The transfer transistor M11 transfers the charge held in the photoelectric conversion element PD1 to the node FD by turning on. The transfer transistor M12 transfers the charge held in the photoelectric conversion element PD2 to the node FD by turning on. The charges transferred from the photoelectric conversion elements PD1 and PD2 are held in the capacitance component (floating diffusion capacitance) of the node FD. As a result, the node FD becomes a potential corresponding to the amount of charge transferred from the photoelectric conversion elements PD1 and PD2 by the charge-voltage conversion by the floating diffusion capacitance.

The select transistor M4 connects the amplifier transistor M3 to the vertical output line 16n by turning on. The amplifier transistor M3 is configured such that a voltage VDD is supplied to the drain and a bias current is supplied from the current source 18 via the vertical output line 16n and the select transistor M4 to the source, and constitutes an amplifier unit (source follower circuit) having the gate as an input node. Accordingly, the amplifier transistor M3 outputs a signal based on the voltage of the node FD to the vertical output line 16n via the select transistor M4. In this sense, the amplifier transistor M3 and the select transistor M4 are an output unit that outputs a pixel signal corresponding to the amount of charge held in the node FD.

The reset transistor M2 has a function of controlling supply of a voltage (voltage VDD) for resetting the node FD serving as a charge holding portion to the FD node. The reset transistor M2 resets the node FD to a voltage corresponding to the voltage VDD by turning on. At this time, by simultaneously turning on the transfer transistor M11, the photoelectric conversion element PD1 may be reset to a voltage corresponding to the voltage VDD. Further, by simultaneously turning on the transfer transistor M12, the photoelectric conversion element PD2 may be reset to a voltage corresponding to the voltage VDD.

By appropriately controlling the transfer transistors M11 and M12, the reset transistor M2, and the select transistor M4, a signal corresponding to the reset voltage of the node FD and a signal corresponding to the amount of incident light to the photoelectric conversion elements PD1 and PD2 are read out from each unit pixel 12. Hereinafter, a signal corresponding to the reset voltage of the node FD is referred to as a noise signal (N-signal), and a signal corresponding to the amount of incident light to the photoelectric conversion elements PD1 and PD2 is referred to as a photoelectric conversion signal (S-signal).

In the unit pixel 12 of the present embodiment, two photoelectric conversion elements PD1 and PD2 share one floating diffusion (node FD). It is possible to separately read out a pixel signal based on the charge generated by the photoelectric conversion element PD1 and a signal based on the charge generated by the photoelectric conversion element PD2 from such a unit pixel 12. In this case, first, the N-signal and the S-signal based on the charge generated in the photoelectric conversion element PD1 may be read out, and then the N-signal and the S-signal based on the charge generated in the photoelectric conversion element PD2 may be read out.

Next, a configuration example of the null pixel 22 in the photoelectric conversion device according to the present embodiment will be described with reference to FIG. 3. FIG. 3 illustrates a null pixel 22(k, n) arranged in the k-th row and the n-th column among the plurality of null pixels 22 constituting the pixel region 20. Here, k is an integer of 1 to K, and n is an integer of 1 to N. The circuit configuration of the other null pixels 22 constituting the pixel region 20 may be similar to that of the null pixel 22(k, n).

For example, as illustrated in FIG. 3, the null pixel 22(k, n) may include a reset transistor M5, an amplifier transistor M6, and a select transistor M7. That is, the null pixel 22 is different from the unit pixel 12 in that it does not include the photoelectric conversion elements PD1 and PD2 and the transfer transistors M11 and M12. The physical configurations of the reset transistor M5, the amplifier transistor M6, and the select transistor M7 may be similar to those of the reset transistor M2, the amplifier transistor M3, and the select transistor M4 of the unit pixel 12.

A source of the reset transistor M5 is connected to a gate of the amplifier transistor M6. A node FDn to which the source of the reset transistor M5 and the gate of the amplifier transistor M6 are connected is a floating diffusion similar to the node FD of the unit pixel 12. A drain of the reset transistor M5 and a drain of the amplifier transistor M6 are connected to a node to which a power supply voltage (voltage VDD) is supplied. A source of the amplifier transistor M6 is connected to a drain of the select transistor M7. A source of the select transistor M7 is connected to the vertical output line 16n.

In the circuit configuration of FIG. 3, the control line 24_k of the k-th row includes two signal lines including a signal line connected to a gate of the reset transistor M5 and a signal line connected to a gate of the select transistor M7. A control signal NRSTk is supplied from the vertical driving circuit 30 to the gates of the reset transistors M5 of the null pixels 22 of the k-th row. A control signal NSELk is supplied from the vertical driving circuit 30 to the gates of the select transistors M7 of the null pixels 22 of the k-th row.

As described above, the reset transistor M5, the amplifier transistor M6, and the select transistor M7 of the null pixel 22 have the same configuration as the reset transistor M2, the amplifier transistor M3, and the select transistor M4 of the unit pixel 12. Therefore, from the N-signal of the unit pixel 12, the N-signal excluding the influence of the photoelectric conversion elements PD1 and PD2 and the transfer transistors M11 and M12 may be read out from the null pixel 22.

Next, an example of connection between the unit pixels 12 and the null pixels 22, and the vertical output line 16 will be described with reference to FIG. 4. In the present embodiment, as an example, a case where the vertical output line 16 of each column includes four output lines is described, but the number of output lines included in the vertical output line 16 of each column is not limited to four.

When the vertical output line 16 of each column is formed of four output lines, the vertical output line 16n of the n-th column includes, for example, an output line 16n1, an output line 16n2, an output line 16n3, and an output line 16n4 as illustrated in FIG. 4. The pixel region 20 includes at least the same number of rows as the number of output lines constituting the vertical output line 16 of each column.

Each unit pixel 12 is connected to any one of the four output lines of the vertical output line 16 arranged in the corresponding column. For example, as illustrated in FIG. 4, a unit pixel 12(K+1, n) arranged in the (K+1)-th row and the n-th column is connected to the output line 16n1 constituting the vertical output line 16n of the n-th column. A unit pixel 12(K+2, n) arranged in the (K+2)-th row and the n-th column is connected to the output line 16n2 constituting the vertical output line 16n of the n-th column. A unit pixel 12(K+3, n) arranged in the (K+3)-th row and the n-th column is connected to the output line 16n3 constituting the vertical output line 16n of the n-th column. A unit pixel 12(K+4, n) arranged in the (K+4)-th row and the n-th column is connected to the output line 16n4 constituting the vertical output line 16n of the n-th column. Similarly to the unit pixels 12 in the (K+1)-th row to the (K+4)-th rows, the unit pixels 12 in the (K+5)-th row and the subsequent rows are also connected to any one of the output lines 16n1 to 16n4 at a period of four rows.

Control signals RSTm, TX1m, TX2m, and SELm are supplied from the vertical driving circuit 30 to the unit pixels 12 arranged in the (K+m)-th row. For example, control signals RST1, TX11, TX21, and SEL1 are supplied from the vertical driving circuit 30 to the unit pixels 12 arranged in the (K+1)-th row. Control signals RST2, TX12, TX22 and SEL2 are supplied from the vertical driving circuit 30 to the unit pixels 12 arranged in the (K+2)-th row. The same applies to the unit pixels 12 in the (K+3)-th row and the subsequent rows.

It can be said that, in the unit pixel 12 of the present embodiment, a pixel including the photoelectric conversion element PD1 and the transfer transistor M11 and a pixel including the photoelectric conversion element PD2 and the transfer transistor M12 share the reset transistor M2, the amplifier transistor M3, and the select transistor M4. By configuring the unit pixel 12 in this manner, the number of transistors per pixel may be reduced as compared with a pixel configuration in which the reset transistor M2, the amplifier transistor M3, and the select transistor M4 are not shared. Therefore, for example, in the case of assuming a layout in which the photoelectric conversion elements have the same area, it is possible to reduce the size of a pixel as compared with a pixel configuration in which the reset transistor M2, the amplifier transistor M3, and the select transistor M4 are not shared.

Each null pixel 22 is connected to any one of the four output lines of the vertical output line 16 arranged in the corresponding column. For example, as illustrated in FIG. 4, a null pixels 22(1, n) arranged in the first row and the n-th column is connected to the output line 16n1 constituting the vertical output line 16n of the n-th column. A null pixel 22(2, n) arranged in the second row and the n-th column is connected to the output line 16n2 constituting the vertical output line 16n of the n-th column. A null pixel 22(3, n) arranged in the third row and the n-th column is connected to the output line 16n3 constituting the vertical output line 16n of the n-th column. A null pixel 22(4, n) arranged in the fourth row and the n-th column is connected to the output line 16n4 constituting the vertical output line 16n of the n-th column.

Control signals NRSTk and NSELk are supplied from the vertical driving circuit 30 to the null pixels 22 arranged in the k-th row. For example, the control signals NRST1 and NSEL1 are supplied from the vertical driving circuit 30 to the null pixels 22 arranged in the first row. Control signals NRST2 and NSEL2 are supplied from the vertical driving circuit 30 to the null pixels 22 arranged in the second row. The same applies to null pixels 22 in the third and subsequent rows.

Next, a configuration example of the vertical driving circuit 30 in the photoelectric conversion device according to the present embodiment will be described with reference to FIG. 5.

As illustrated in FIG. 5, the vertical driving circuit 30 in the photoelectric conversion device according to the present embodiment includes a vertical scanning unit 32 and a vertical logic unit 34. The vertical logic unit 34 includes M-number of unit vertical logic sections 36 corresponding to M-number of rows constituting the pixel region 10, and K-number of unit vertical logic sections 42 corresponding to K-number of rows constituting the pixel region 20. Each of the unit vertical logic sections 36 includes a logic generation unit 38 and an operation unit 40. Each of the unit vertical logic sections 42 includes a logic generation unit 44 and an operation unit 46.

The vertical scanning unit 32 serves as a selection circuit for selecting the unit vertical logic sections 36 and 42 corresponding to the plurality of rows constituting the pixel regions 10 and 20. The vertical scanning unit 32 generates the row selection signals DEC<K+1> to DEC<K+M> corresponding to the respective rows of the pixel region 10 and the row selection signals DEC<1> to DEC<K> corresponding to the respective rows of the pixel region 20 in accordance with a control signal from the system control unit 90. The row selection signals DEC<K+1> to DEC<K+M> are selection signals for selecting the unit vertical logic section 36, and are input to the unit vertical logic section 36 of the corresponding row. The vertical scanning unit 32 may be configured by an address decoder or a shift register. When the vertical scanning unit 32 is configured by an address decoder, the control signal input from the system control unit is an address signal, and the row selection signals DEC<1> to DEC<K> and DEC<K+1> to DEC<K+M> are decoded signals obtained by decoding the address signal.

The row selection signals DEC<1> to DEC<K> are selection signals for selecting the unit vertical logic section 42, and are input to the unit vertical logic section 42 of the corresponding row. The vertical scanning unit 32 is also a scanning circuit configured to sequentially select a part of the plurality of rows corresponding to the unit vertical logic sections 36 among a plurality of rows constituting the pixel regions 10 and 20. The configuration in which each row is selected by the row selection signal DEC is the same in the unit vertical logic sections 42 and 36. Control signals VLSELk generated by a control circuit 92 under the control of the system control unit 90 are input to the unit vertical logic sections 42 of the respective rows.

The logic generation unit 44 of the unit vertical logic section 42 of the k-th row outputs a logic value corresponding to the row selection signal DEC<k> and the control signal from the system control unit 90. The operation unit 46 of the unit vertical logic section 42 of the k-th row generates the control signals NRSTk and NSELk in accordance with the logic value input from the logic generation unit 44, the control signals from the system control unit 90, and the control signal VLSELk from the control circuit 92. The generated control signals NRSTk and NSELk are output to the null pixel 22(k, n) via the control line 24_k. Here, the control signal VLSELk is a signal for determining whether the horizontal scanning period of interest is a horizontal scanning period during which the pixel signal is read out to the output line 16nk or a horizontal scanning period during which the pixel signal is not read out to the output line 16nk.

When the control signal VLSELk is at high-level and the horizontal scanning period during which no pixel signal is read out to the output line 16nk, the operation unit 46 allows the control signals NRSTk and NSELk to be output to the null pixel 22(k, n) regardless of the row selection signal DEC<k>. The logic circuit constituting the operation unit 46 is not particularly limited, but may include, for example, an OR circuit that receives the output of the logic generation unit 44 and the control signal VLSELk, and an AND circuit that receives the output of the OR circuit and the control signal from the system control unit 90.

The logic generation unit 38 of the unit vertical logic section 36 of the (K+m)-th row outputs a logic value corresponding to the row selection signal DEC<K+m> and the control signal from the system control unit 90. The operation unit 40 of the unit vertical logic section 36 of the (K+m)-th row generates the control signals RSTm, SELm, TX11m, and TX21m in accordance with the logic value input from the logic generation unit 38 and the control signals from the system control unit 90. The generated control signals RSTm, SELm, TX11m, and TX21m are output to the unit pixel 12(K+m, n) via the control line 14_m. The unit vertical logic section 36 controls output of the control signals RSTm, SELm, TX11m, and TX21m to the unit pixel 12(K+m, n) in accordance with the row selection signal DEC<K+m>. That is, the control signals RSTm, SELm, TX11m, and TX21m are not supplied from the unit vertical logic section 36 to the control line 14_m except for the period in which the unit vertical logic section 36 is selected by the row selection signal DEC<K+m>.

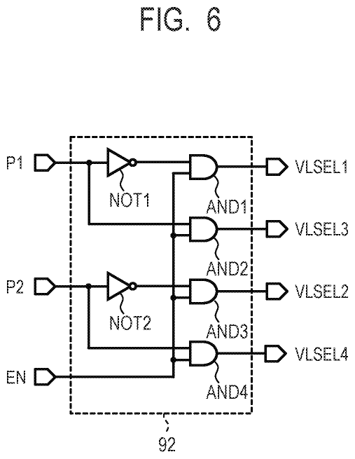

The control circuit 92 serves as a selection circuit to select a row among the other part of the plurality of rows constituting the pixel regions 10 and 20 corresponding to the prescribed unit vertical logic sections 42. The control circuit 92 includes an input unit to which a control signal different from the control signal (for example, an address signal) input to the vertical scanning unit 32 is input. For example, as illustrated in FIG. 6, the control circuit 92 may be configured as a circuit that receives pulse signals P1 and P2 and an enable signal EN from the system control unit 90 as input signals and outputs the control signals VLSEL1, VLSEL2, VLSEL3, and VLSEL4. The logic circuit constituting the control circuit 92 is not particularly limited, but may include logic circuits NOT1, NOT2, AND1, AND2, AND3, and AND4 as illustrated in FIG. 6.

The pulse signal P1 is input to an input node of the logic circuit NOT1. The pulse signal P2 is input to an input node of the logic circuit NOT2. An output signal of the logic circuit NOT1 and the enable signal EN are input to two input nodes of the logic circuit AND1. An output signal of the logic circuit AND1 becomes the control signal VLSEL1. The pulse signal P1 and the enable signal EN are input to two input nodes of the logic circuit AND2. An output signal of the logic circuit AND2 becomes the control signal VLSEL3. An output signal of the logic circuit NOT2 and the enable signal EN are input to two input nodes of the logic circuit AND3. An output signal of the logic circuit AND3 becomes the control signal VLSEL2. The pulse signal P2 and the enable signal EN are input to two input nodes of the logic circuit AND4. An output signal of the logic circuit AND4 becomes the control signal VLSEL4.

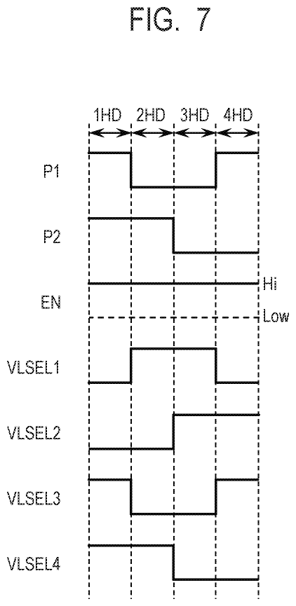

Next, the operation of the control circuit 92 will be described with reference to FIG. 7. FIG. 7 illustrates an operation example of the control circuit 92 in four consecutive horizontal scanning periods (a first horizontal scanning period 1HD to a fourth horizontal scanning period 4HD). The operation of generating the control signals VLSEL1 to VLSEL4 by the pulse signals P1 and P2 may be repeated with four horizontal scanning periods illustrated in FIG. 7 as one cycle.

The pulse signal P1 becomes high-level in the first horizontal scanning period 1HD and the fourth horizontal scanning period 4HD, and becomes low-level in the second horizontal scanning period 2HD and the third horizontal scanning period 3HD. The pulse signal P2 becomes high-level in the first horizontal scanning period 1HD and the second horizontal scanning period 2HD, and becomes low-level in the third horizontal scanning period 3HD and the fourth horizontal scanning period 4HD. The enable signal EN is at high-level during the period from the first horizontal scanning period 1HD to the fourth horizontal scanning period 4HD.

As illustrated in FIG. 7, when the enable signal EN is at high-level, the inverted pulse of the pulse signal P1 becomes the control signal VLSEL1, and the in-phase pulse of the pulse signal P1 becomes the control signal VLSEL3. When the enable signal EN is at high-level, the inverted pulse of the pulse signal P2 becomes the control signal VLSEL2, and the in-phase pulse of the pulse signal P2 becomes the control signal VLSEL4.

Therefore, when the pulse signals P1 and P2 transit as illustrated in FIG. 7, the control signals VLSEL1 and VLSEL2 become low-level and the control signals VLSEL3 and VLSEL4 become high-level during the first horizontal scanning period 1HD. During the second horizontal scanning period 2HD, the control signals VLSEL2 and VLSEL3 become low-level, and the control signals VLSEL1 and VLSEL4 become high-level. During the third horizontal scanning period 3HD, the control signals VLSEL3 and VLSEL4 become low-level, and the control signals VLSEL1 and VLSEL2 become high-level. During the fourth horizontal scanning period 4HD, the control signals VLSEL1 and VLSEL4 become low-level, and the control signals VLSEL2 and VLSEL3 become high-level.

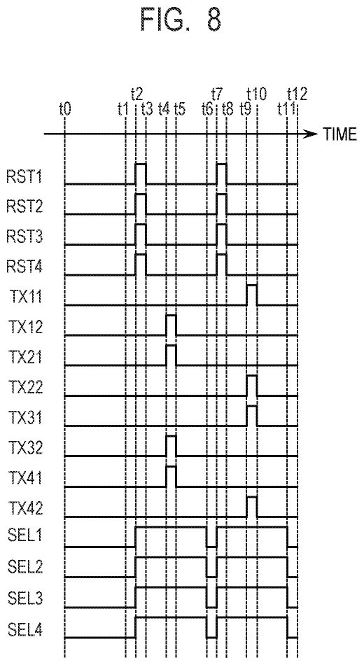

Next, a method of driving the photoelectric conversion device according to the present embodiment will be described with reference to FIG. 8 and FIG. 9. FIG. 8 and FIG. 9 are timing charts illustrating a method of driving the photoelectric conversion device according to the present embodiment.

First, a basic driving example of the photoelectric conversion device according to the present embodiment will be described with reference to FIG. 8. Here, an operation of reading out pixel signals from the unit pixels 12(K+1, n), 12(K+2, n), 12(K+3, n), and 12(K+4, n) illustrated in FIG. 4 will be described.

In the following description, among the constituent elements of the unit pixel 12, each of a portion that contributes to the readout of the signal from the photoelectric conversion element PD1 and a portion that contributes to the readout of the signal from the photoelectric conversion element PD2 may be referred to as a “pixel” for convenience. Specifically, with respect to the unit pixel 12(K+1, n), pixel elements that contributes to the readout of the signal from the photoelectric conversion element PD1 is defined as a pixel A, and pixel elements that contributes to the readout of the signal from the photoelectric conversion element PD2 is defined as a pixel B. With respect to the unit pixel 12(K+2, n), pixel elements that contributes to the readout of the signal from the photoelectric conversion element PD1 is defined as a pixel C, and pixel elements that contributes to the readout of the signal from the photoelectric conversion element PD2 is defined as a pixel D. With respect to the unit pixel 12(K+3, n), pixel elements that contributes to the readout of the signal from the photoelectric conversion element PD1 is defined as a pixel E, and pixel elements that contributes to the readout of the signal from the photoelectric conversion element PD2 is defined as a pixel F. For the unit pixel 12(K+4, n), pixel elements that contributes to the readout of the signal from the photoelectric conversion element PD1 is referred to as a pixel G, and pixel elements that contributes to the readout of the signal from the photoelectric conversion element PD2 is referred to as a pixel H.

The pixel elements that contribute to reading out the signal from the photoelectric conversion element PD1 include the photoelectric conversion element PD1, the transfer transistor M11, the reset transistor M2, the amplifier transistor M3, and the select transistor M4. The pixel elements that contribute to the reading out the signal from the photoelectric conversion element PD2 include the photoelectric conversion element PD2, the transfer transistor M12, the reset transistor M2, the amplifier transistor M3, and the select transistor M4.

FIG. 8 is a timing diagram illustrating a driving mode in which all the output lines constituting the vertical output line 16 are used to read out pixel signals at an arbitrary time. More specifically, each of the four output lines constituting the vertical output line 16 of each column is connected to the unit pixel 12 during each horizontal scanning period, and pixel signals are read out from the four output lines. FIG. 8 illustrates control signals RST1 to RST4, TX11 to TX42, and SEL1 to SEL4 supplied from the vertical driving circuit 30. In this driving example, signals are not read out from the null pixels 22 in the pixel region 20.

A period from time t0 to time t1 is a state before the start of readout. In this period, all of the control signals RST1 to RST4, TX11 to TX42, and SEL1 to SEL4 are at low-level, i.e., in an inactive state.

A period from the time t1 to time t6 corresponds to one horizontal scanning period in which the N-signal and the S-signal are read out from each of the pixel B, the pixel C, the pixel F, and the pixel G.

At time t2, the vertical driving circuit 30 controls the control signals RST1, RST2, RST3, RST4, SEL1, SEL2, SEL3 and SEL4 from low-level to high-level. As a result, the select transistors M4 of the unit pixels 12(K+1, n) to 12(K+4, n) are turned on, and the unit pixels 12(K+1, n) to 12(K+4, n) are connected to the output lines 16n1 to 16n4, respectively. Further, the reset transistor M2 of each of the unit pixels 12(K+1, n) to 12(K+4, n) is turned on, and the reset operation of the node FD is started.

At the subsequent time t3, the vertical driving circuit 30 controls the control signals RST1, RST2, RST3, and RST4 from high-level to low-level. As a result, the reset transistors M2 of the unit pixels 12(K+1, n) to 12(K+4, n) are turned off, and the reset state of the nodes FD is released. When the reset transistor M2 is turned off, the potential of the node FD is reduced to a predetermined potential by coupling with the gate of the reset transistor M2. The voltage of the node FD settled after the reset transistor M2 turns off is the reset voltage of the node FD.

Thereby, a signal corresponding to the reset voltage of the node FD of the unit pixel 12(K+1, n) is output to the output line 16n1 via the amplifier transistor M3 and the select transistor M4. Similarly, signals corresponding to the reset voltages of the nodes FD of the unit pixels 12(K+2, n) to 12(K+4, n) are output to the output lines 16n2 to 16n3, respectively.

A signal output from the unit pixel 12(K+1, n) to the output line 16n1 is processed by the column circuit unit 50 in the subsequent stage, and is read out as an N-signal of the pixel B. Similarly, signals output from the unit pixels 12(K+2, n) to 12(K+4, n) to the output lines 16n2, 16n3, 16n4 are read out as N-signals of the pixels C, F, and G, respectively.

At the subsequent time t4, the vertical driving circuit 30 controls the control signals TX12, TX21, TX32, and TX41 from low-level to high-level. As a result, the transfer transistors M11 of the unit pixels 12(K+2, n) and 12(K+4, n) are turned on, and the charges accumulated in the photoelectric conversion elements PD1 of the unit pixels 12(K+2, n) and 12(K+4, n) during a predetermined exposure period are transferred to the nodes FD. The transfer transistors M12 of the unit pixels 12(K+1, n) and 12(K+3, n) are turned on, and the charges accumulated in the photoelectric conversion element PD2 of the unit pixels 12(K+1, n) and 12(K+3, n) during a predetermined exposure period are transferred to the nodes FD.

Thereby, a signal corresponding to the amount of charge generated in the photoelectric conversion element PD2 of the unit pixel 12(K+1, n) is output to the output line 16n1 via the amplifier transistor M3 and the select transistor M4. Similarly, a signal corresponding to the amount of charge generated in the photoelectric conversion element PD1 of the unit pixel 12(K+2, n) is output to the output line 16n2 via the amplifier transistor M3 and the select transistor M4. A signal corresponding to the amount of charge generated in the photoelectric conversion element PD2 of the unit pixel 12(K+3, n) is output to the output line 16n3 via the amplifier transistor M3 and the select transistor M4. A signal corresponding to the amount of charge generated in the photoelectric conversion element PD1 of the unit pixel 12(K+4, n) is output to the output line 16n4 via the amplifier transistor M3 and the select transistor M4.

At the subsequent time t5, the vertical driving circuit 30 controls the control signals TX12, TX21, TX32, and TX41 from high-level to low-level. Thus, the charge transfer period from the photoelectric conversion elements PD1 and PD2 to the nodes FD in the unit pixels 12(K+1, n) to 12(K+4, n) ends. A signal output from the unit pixel 12(K+1, n) to the output line 16n1 is processed by the column circuit unit 50 in the subsequent stage after settling, and is read out as an S-signal of the pixel B. Similarly, signals output from the unit pixels 12(K+2, n), 12(K+3, n), and 12(K+4, n) to the output lines 16n2, 16n3, and 16n4 are read out as S-signals of the pixels C, F, and G, respectively.

At the subsequent time t6, the vertical driving circuit 30 controls the control signals SEL1, SEL2, SEL3, and SEL4 from high-level to low-level. As a result, the select transistors M4 of the unit pixels 12(K+1, n) to 12(K+4, n) that have been read out are turned off, and the unit pixels 12(K+1, n) to 12(K+4, n) are disconnected from the output lines 16n1 to 16n4.

The period from the subsequent time t7 to time t11 corresponds to one horizontal scanning period in which the N-signal and the S-signal are read out from each of the pixel A, the pixel D, the pixel E, and the pixel H in the same manner as the period from the time t2 to the time t6.

In this manner, pixel signals are read out from eight pixels of the pixel A, the pixel B, the pixel C, the pixel D, the pixel E, the pixel F, the pixel G, and the pixel H through the two horizontal scanning periods from the time t1 to the time t11. Thereafter, the pixel region 10 is sequentially scanned from the fifth row in units of four rows by the same procedure, and the pixel signals are read out from the entire pixel region 10.

Next, a driving example in which two of the four output lines constituting the vertical output line 16 of each column are connected to the unit pixels 12 and the pixel signals are read out from the unit pixels 12 connected to the output lines will be described with reference to FIG. 9.

Parasitic capacitances exist between adjacent output lines of the plurality of output lines forming the vertical output line of one column. In the solid-state imaging device described in International Publication No. WO2015/151793, when a pixel signal is read out from a part of output lines of a plurality of output lines constituting a vertical output line of one column, the other output lines are fixed to a predetermined voltage before the readout. Therefore, the influence of the parasitic capacitance between the output line from which the pixel signal is read out and the output line from which the pixel signal is not read out varies depending on the potential state of the adjacent output lines. As a result, a coupling amount from the vertical output line to the node FD at the time of reading out the reset signal and a settling time of the reset signal may vary among the output lines constituting the same vertical output line. When images of the same black level are captured, the amounts of signals to be read out differ between the output lines, and steps may be generated as an image to deteriorate the image quality. In order to solve such a problem, in this driving example, a signal from the null pixel 22 is output to an output line which does not output a signal from the unit pixel 12.

FIG. 9 is a timing chart illustrating a driving mode in which a part of the output lines constituting the vertical output line 16 is not used for reading out pixel signals at an arbitrary time. FIG. 9 illustrates control signals RST1 to RST4, TX11 to TX42, SEL1 to SEL4, NRST1 to NRST4, and NSEL1 to NSEL4 supplied from the vertical driving circuit 30. FIG. 9 also illustrates control signals VLSEL1 to VLSEL4 supplied from the control circuit 92 to the vertical driving circuit 30. It is assumed that each control signal is in an active state when it is at high-level, and is in an inactive state when it is at low-level.

A period from time t20 to time t21 is a state before the start of readout. In this period, all of the control signals RST1 to RST4, TX11 to TX42, SEL1 to SEL4, NRST1 to NRST4, and NSEL1 to NSEL4 are at low-level, i.e., in an inactive state. The enable signal EN (not illustrated) is at low-level, and the control signals VLSEL1 to VLSEL4 are also at low-level.

A period from the time t21 to time t26 corresponds to one horizontal scanning period in which the N-signal and the S-signal are read out from each of the pixel B and the pixel C. This one horizontal scanning period corresponds to the first horizontal scanning period 1HD in FIG. 7.

At the time t21, the system control unit 90 controls the enable signal EN and the pulse signals P1 and P2 supplied to the control circuit 92 from low-level to high-level. Thereby, the control signals VLSEL1 and VLSEL2 become low-level, and the control signals VLSEL3 and VLSEL4 become high-level.

At the subsequent time t22, the vertical driving circuit 30 controls the control signals RST1, RST2, SEL1, and SEL2 from low-level to high-level. As a result, the select transistors M4 of the unit pixels 12(K+1, n) and 12(K+2, n) are turned on, and the unit pixel 12(K+1, n) is connected to the output line 16n1, and the unit pixel 12(K+2, n) is connected to the output line 16n2. The reset transistor M2 of each of the unit pixels 12(K+1, n) and 12(K+2, n) is turned on, and the reset operation of the node FD is started.

At the time t22, the vertical driving circuit 30 controls the control signals NRST3, NRST4, NSEL3, and NSEL4 from low-level to high-level in response to the control signals VLSEL3 and VLSEL4 being at high-level. As a result, the select transistors M7 of the null pixels 22(3, n) and 22(4, n) are turned on, and the null pixels 22(3, n) is connected to the output line 16n3, and the null pixel 22(4, n) is connected to the output line 16n4. The reset transistor M5 of each of the null pixels 22(3, n) and 22(4, n) is turned on, and the reset operation of the node FDn is started.

At the subsequent time t23, the vertical driving circuit 30 controls the control signals RST1, RST2, NRST3, and NRST4 from high-level to low-level. Thereby, the reset transistor M2 of each of the unit pixels 12(K+1, n) and 12(K+2, n) is turned off, and the reset state of the node FD is released. When the reset transistor M2 is turned off, the potential of the node FD is reduced to a predetermined potential by coupling with the gate of the reset transistor M2. The voltage of the node FD settled after the reset transistor M2 turns off is the reset voltage of the node FD. Further, the reset transistor M5 of each of the null pixels 22(3, n) and 22(4, n) is turned off, and the reset state of the node FDn is released. When the reset transistor M5 is turned off, the potential of the node FDn is reduced to a predetermined potential by coupling with the gate of the reset transistor M5. The voltage of the node FDn settled after the reset transistor M5 turns off is the reset voltage of the node FDn.

Thereby, a signal corresponding to the reset voltage of the node FD of the unit pixel 12(K+1, n) is output to the output line 16n1, and a signal corresponding to the reset voltage of the node FD of the unit pixel 12(K+2, n) is output to the output line 16n2. A signal corresponding to the reset voltage of the node FDn of the null pixel 22(3, n) is output to the output line 16n3, and a signal corresponding to the reset voltage of the node FDn of the null pixel 22(4, n) is output to the output line 16n4.

A transitional potential change of the output line constituting the vertical output line 16n is affected by parasitic capacitance components such as coupling with other output lines constituting the vertical output line 16n, parasitic resistance components of interconnections, and the like. For example, the output line 16n1 is coupled to the output line 16n2 adjacent thereto, and the output line 16n2 is coupled to the output lines 16n1 and 16n3 adjacent thereto.

During a period from the time t22 to time t24, the potential of the output line 16n1 is changed by reading out the N-signal of the pixel B, and the potential of the output line 16n2 is changed by reading out the N-signal of the pixel C. At this time, the N-signal of the pixels constituting the unit pixel 12 is not read out to the output lines 16n3 and 16n4. However, the potential of the output line 16n3 is changed by reading out the N-signal of the null pixel 22(3, n), and the potential of the output line 16n4 is changed by reading out the N-signal of the null pixel 22(4, n).

In this way, by reading out the N-signals from the null pixels 22 to the output lines which do not read out the N-signal from the unit pixel 12, the potentials of the four output lines 16n1 to 16n4 constituting the vertical output line 16n change in the same manner at the same timing. Thus, the influence of the parasitic capacitances between the output lines 16n1 to 16n4 may be approximately equalized.

At the subsequent time t24, the vertical driving circuit 30 controls the control signals TX12 and TX21 from low-level to high-level. Thereby, the transfer transistor M12 of the unit pixel 12(K+1, n) is turned on, and the charge accumulated in the photoelectric conversion element PD2 of the unit pixel 12(K+1, n) during a predetermined exposure period is transferred to the node FD. Further, the transfer transistor M11 of the unit pixel 12(K+2, n) is turned on, and the charge accumulated in the photoelectric conversion element PD1 of the unit pixel 12(K+2, n) during a predetermined exposure period is transferred to the node FD.

Thereby, a signal corresponding to the amount of charge generated in the photoelectric conversion element PD2 of the unit pixel 12(K+1, n) is output to the output line 16n1 via the amplifier transistor M3 and the select transistor M4. Similarly, a signal corresponding to the amount of charge generated in the photoelectric conversion element PD1 of the unit pixel 12(K+2, n) is output to the output line 16n2 via the amplifier transistor M3 and the select transistor M4.

At the subsequent time t25, the vertical driving circuit 30 controls the control signals TX12 and TX21 from high-level to low-level. Thus, the charge transfer period from the photoelectric conversion element PD2 to the node FD in the unit pixel 12(K+1, n) and the charge transfer period from the photoelectric conversion element PD1 to the node FD in the unit pixel 12(K+2, n) are completed.

At the subsequent time t26, the vertical driving circuit 30 controls the control signals SEL1, SEL2, NSEL3, and NSEL4 from high-level to low-level. As a result, the select transistors M4 of the unit pixels 12(K+1, n) and 12(K+2, n) that have been read out are turned off, and the unit pixels 12(K+1, n) and 12(K+2, n) are disconnected from the output lines 16n1 and 16n2. Further, the select transistors M7 of the null pixels 22(3, n) and 22(4, n) are turned off, and the null pixels 22(3, n) and 22(4, n) are disconnected from the output lines 16n3 and 16n4.

A period from the time t26 to time t41 is a period in which the N-signals and the S-signals are read out from the pixel A, the pixel D, the pixel E, the pixel F, the pixel G, and the pixel H in the same manner as the readout of the N-signals and the S-signals from the pixel B and the pixel C in the period from the time t21 to the time t26.

A period from the time t26 to time t31 corresponds to one horizontal scanning period in which the N-signal and the S-signal are read out from each of the pixel D and the pixel E. This one horizontal scanning period corresponds to the second horizontal scanning period 2HD in FIG. 7. In the readout of the pixel D, the control signal SEL2 becomes an active state, and the N-signal and the S-signal are read out to the output line 16n2. In the readout of the pixel E, the control signal SEL3 becomes an active state, and the N-signal and the S-signal are read out to the output line 16n3.

During the period from the time t26 to the time t31, the control signals NSEL1 and NSEL4 are in an active state in response to high-level of the control signals VLSEL1 and VLSEL4. Thereby, the N-signal of the null pixel 22(1, n) is read out to the output line 16n1, and the N-signal of the null pixel 22(4, n) is read out to the output line 16n4. As described above, by reading out the N-signal from the null pixel 22 to the output line to which the N-signal is not read out from the unit pixel 12, the potentials of the four output lines 16n1 to 16n4 constituting the vertical output line 16n change in the same manner at the same timing. Thus, the influence of the parasitic capacitances between the output lines 16n1 to 16n4 may be approximately equalized.

A period from the time t31 to time t36 corresponds to one horizontal scanning period in which the N-signal and the S-signal are read out from each of the pixel F and the pixel G. This one horizontal scanning period corresponds to the third horizontal scanning period 3HD in FIG. 7. In the readout of the pixel F, the control signal SEL3 becomes an active state, and the N-signal and the S-signal are read out to the output line 16n3. In the readout out the pixel G, the control signal SEL4 becomes an active state, and the N-signal and the S-signal are read out to the output line 16n4.

During the period from the time t31 to the time t36, the control signals NSEL1 and NSEL2 are in an active state in response to high-level of the control signals VLSEL1 and VLSEL2. Thereby, the N-signal of the null pixel 22(1, n) is read out to the output line 16n1, and the N-signal of the null pixel 22(2, n) is read out to the output line 16n2. As described above, by reading out the N-signal from the null pixel 22 to the output line to which the N-signal is not read out from the unit pixel 12, the potentials of the four output lines 16n1 to 16n4 constituting the vertical output line 16n change in the same manner at the same timing. Thus, the influence of the parasitic capacitances between the output lines 16n1 to 16n4 may be approximately equalized.

A period from the time t36 to the time t41 corresponds to one horizontal scanning period in which the N-signal and the S-signal are read out from each of the pixel A and the pixel H. This one horizontal scanning period corresponds to the fourth horizontal scanning period 4HD in FIG. 7. In the readout of the pixel A, the control signal SELL becomes an active state, and the N-signal and the S-signal are read out to the output line 16n1. In the readout of the pixel H, the control signal SEL4 becomes an active state, and the N-signal and the S-signal are read out to the output line 16n4.

During the period from the time t36 to the time t41, the control signals NSEL2 and NSEL3 are in an active state in response to high-level of the control signals VLSEL2 and VLSEL3. Thereby, the N-signal of the null pixel 22(2, n) is read out to the output line 16n2, and the N-signal of the null pixel 22(3, n) is read out to the output line 16n3. As described above, by reading out the N-signal from the null pixel 22 to the output line to which the N-signal is not read out from the unit pixel 12, the potentials of the four output lines 16n1 to 16n4 constituting the vertical output line 16n change in the same manner at the same timing. Thus, the influence of the parasitic capacitances between the output lines 16n1 to 16n4 may be approximately equalized.

In this manner, through the four horizontal scanning periods from the time t21 to the time t41, pixel signals are read out from eight pixels of the pixel A, the pixel B, the pixel C, the pixel D, the pixel E, the pixel F, the pixel G, and the pixel H. Thereafter, the pixel region 10 is sequentially scanned from the fifth row in units of four rows by the same procedure, and pixel signals are read out from the entire pixel region 10.

As described above, in the present embodiment, by reading out the N-signal of the null pixel 22 to the unselected output line, the influence of the parasitic capacitances from the output lines to the other output lines in the plurality of output lines constituting the vertical output lines 16 of the same column is made uniform. Therefore, according to the present embodiment, it is possible to effectively suppress the potential variation between the output lines and output a high-quality signal with reduced noise.

### Second Embodiment

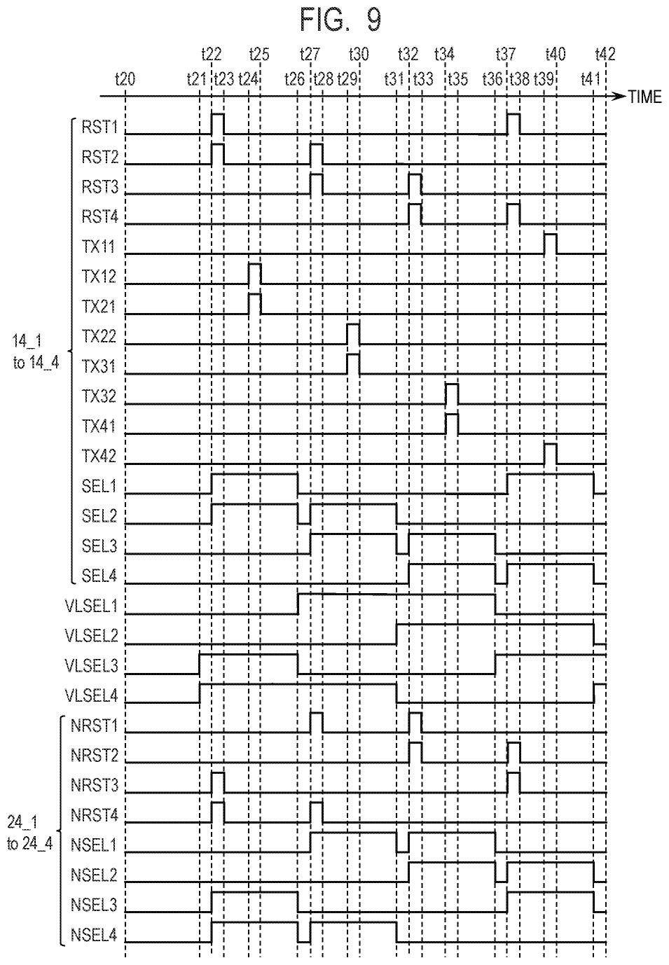

A photoelectric conversion device according to a second embodiment of the present invention will be described with reference to FIG. 10. Components similar to those of the photoelectric conversion device according to the first embodiment are denoted by the same reference numerals, and description thereof will be omitted or simplified. FIG. 10 is a block diagram illustrating a configuration example of the vertical driving circuit 30 in the photoelectric conversion device according to the present embodiment.

The photoelectric conversion device according to the present embodiment is the same as the photoelectric conversion device according to the first embodiment except that the location of the control circuit 92 is different. That is, in the photoelectric conversion device according to the first embodiment, the control circuit 92 is provided outside the vertical driving circuit 30 as a circuit independent of the vertical driving circuit 30. On the other hand, in the photoelectric conversion device according to the present embodiment, as illustrated in FIG. 10, the control circuit 92 is disposed inside the vertical scanning unit 32 of the vertical driving circuit 30. By configuring the photoelectric conversion device in this manner, it is not necessary to route wirings for supplying the control signals VLSEL1 to VLSEL4 from other functional blocks, and an efficient interconnection layout becomes possible. It is also possible to configure logic inside the vertical scanning unit 32 and simplify the configuration of the unit vertical logic section 36. For example, the vertical scanning unit 32 may output a signal after performing logical operation of the row selection signal DEC<k> and the control signal VLSELk. The circuit configuration in the vertical scanning unit 32 is not limited to that illustrated in FIG. 10.

As described above, according to the present embodiment, it is possible to effectively suppress the potential variation between the output lines and output a high-quality signal with reduced noise. Further, efficient interconnection layout may be achieved, and the circuit configuration may be simplified.

### Third Embodiment

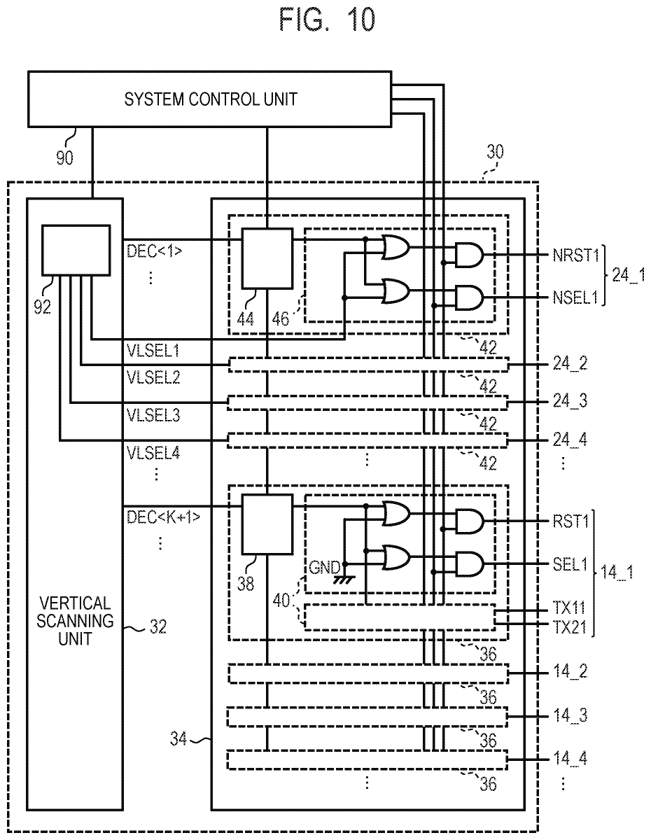

An imaging system according to a third embodiment of the present invention will be described with reference to FIG. 11. FIG. 11 is a block diagram illustrating a schematic configuration of an imaging system according to the present embodiment.

The photoelectric conversion device 100 described in the first and second embodiments may be applied to various imaging systems. Examples of applicable imaging systems include digital still cameras, digital camcorders, surveillance cameras, copying machines, facsimiles, mobile phones, on-vehicle cameras, observation satellites, and the like. A camera module including an optical system such as a lens and an imaging device is also included in the imaging system. FIG. 11 is a block diagram of a digital still camera as an example of these.

The imaging system 200 illustrated in FIG. 11 includes an imaging device 201, a lens 202 for forming an optical image of an object on the imaging device 201, an aperture 204 for varying the amount of light passing through the lens 202, and a barrier 206 for protecting the lens 202. The lens 202 and the aperture 204 form an optical system that collects light on the imaging device 201. The imaging device 201 may be the photoelectric conversion device 100 described in the first or the second embodiment, and converts an optical image formed by the lens 202 into image data.

The imaging system 200 also includes a signal processing unit 208 that processes an output signal output from the imaging device 201. The signal processing unit 208 generates image data from a digital signal output from the imaging device 201. The signal processing unit 208 performs various corrections and compressions as necessary and outputs the processed image data. The imaging device 201 may include an AD conversion unit that generates a digital signal to be processed by the signal processing unit 208. The AD conversion unit may be formed on a semiconductor layer (semiconductor substrate) in which the photoelectric conversion unit of the imaging device 201 is formed, or may be formed on a semiconductor layer different from the semiconductor layer on which the photoelectric conversion unit of the imaging device 201 is formed. The signal processing unit 208 may be formed on the same semiconductor layer as the imaging device 201.

The imaging system 200 further includes a memory unit 210 for temporarily storing image data, and an external interface unit (external OF unit) 212 for communicating with an external computer or the like. The imaging system 200 further includes a storage medium 214 such as a semiconductor memory for storing or reading out the imaging data, and a storage medium control interface unit (storage medium control OF unit) 216 for storing or reading out the imaging data on or from the storage medium 214. The storage medium 214 may be built in the imaging system 200, or may be detachable.

The imaging system 200 further includes a general control/operation unit 218 that controls various calculations and operations of the entire digital still camera, and a timing generation unit 220 that outputs various timing signals to the imaging device 201 and the signal processing unit 208. Here, the timing signal or the like may be input from the outside, and the imaging system 200 may include at least the imaging device 201 and the signal processing unit 208 that processes an output signal output from the imaging device 201.

The imaging device 201 outputs the imaging signal to the signal processing unit 208. The signal processing unit 208 performs predetermined signal processing on the imaging signal output from the imaging device 201, and outputs image data. The signal processing unit 208 generates an image using the imaging signal.

As described above, according to the present embodiment, it is possible to realize an imaging system to which the photoelectric conversion device 100 according to the first or the second embodiment is applied.

### Fourth Embodiment

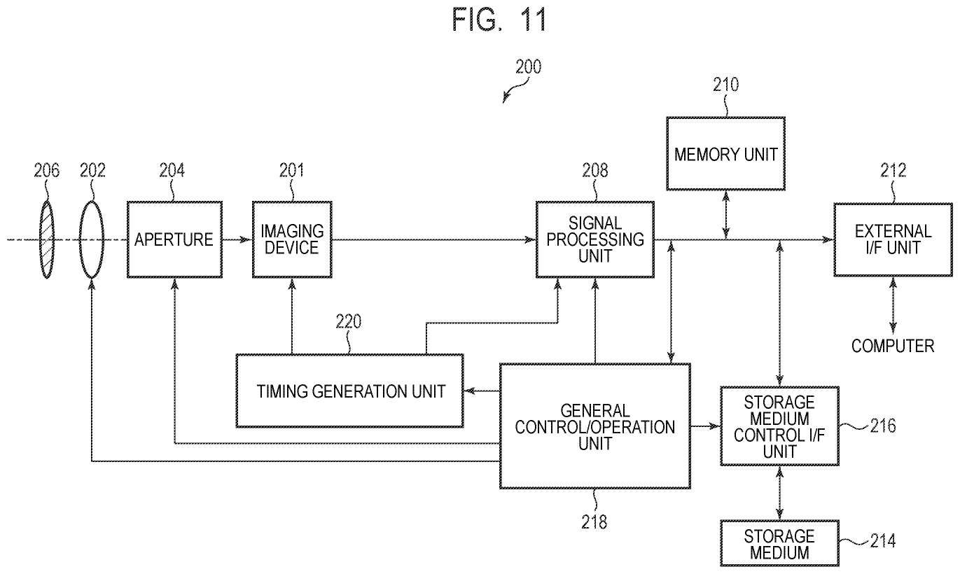

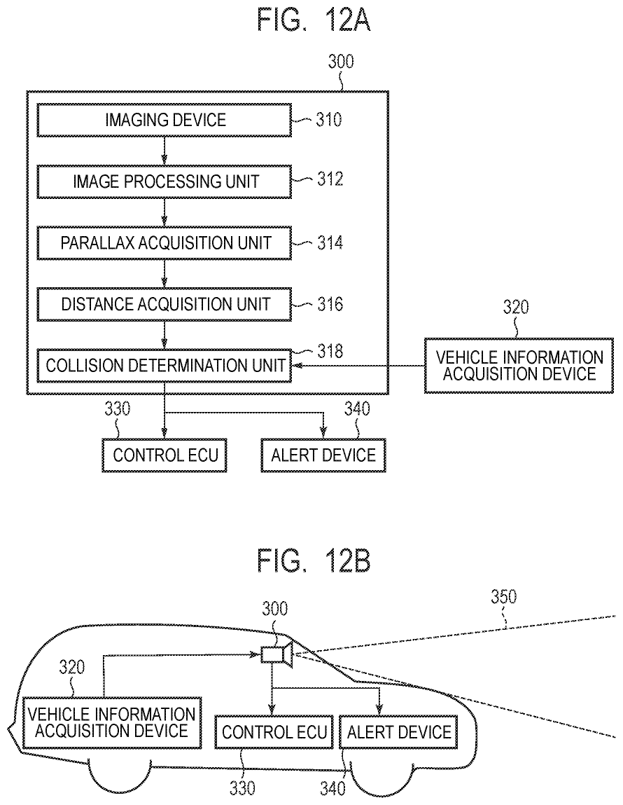

An imaging system and a movable object according to a fourth embodiment of the present invention will be described with reference to FIG. 12A and FIG. 12B. FIG. 12A is a diagram illustrating a configuration of an imaging system according to the present embodiment. FIG. 12B is a diagram illustrating a configuration of a movable object according to the present embodiment.

FIG. 12A illustrates an example of an imaging system relating to an on-vehicle camera. The imaging system 300 includes an imaging device 310. The imaging device 310 may be the photoelectric conversion device 100 described in the first or the second embodiment. The imaging system 300 includes an image processing unit 312 that performs image processing on a plurality of image data acquired by the imaging device 310, and a parallax acquisition unit 314 that calculates parallax (phase difference of parallax images) from the plurality of image data acquired by the imaging device 310. The imaging system 300 includes a distance acquisition unit 316 that calculates a distance to an object based on the calculated parallax, and a collision determination unit 318 that determines whether or not there is a possibility of collision based on the calculated distance. Here, the parallax acquisition unit 314 and the distance acquisition unit 316 are examples of a distance information acquisition unit that acquires distance information to the object. That is, the distance information may be information on a parallax, a defocus amount, a distance to the object, and the like. The collision determination unit 318 may determine the collision possibility using any of these pieces of distance information. The distance information acquisition unit may be implemented by dedicated hardware or software modules. Further, it may be implemented by FPGA (Field Programmable Gate Array), ASIC (Application Specific Integrated circuit), or the like, or may be implemented by a combination of these.

The imaging system 300 is connected to a vehicle information acquisition device 320, and may acquire vehicle information such as a vehicle speed, a yaw rate, and a steering angle. Further, the imaging system 300 is connected to a control ECU 330 which is a control device that outputs a control signal for generating a braking force to the vehicle based on the determination result of the collision determination unit 318. The imaging system 300 is also connected to an alert device 340 that issues an alert to the driver based on the determination result of the collision determination unit 318. For example, when the collision possibility is high as the determination result of the collision determination unit 318, the control ECU 330 performs vehicle control to avoid collision and reduce damage by braking, returning an accelerator, suppressing engine output, or the like. The alert device 340 alerts a user by sounding an alarm such as a sound, displaying alert information on a screen of a car navigation system or the like, or giving vibration to a seat belt or a steering wheel.

In the present embodiment, the imaging system 300 images the periphery of the vehicle, for example, the front or the rear. FIG. 12B illustrates an imaging system in the case of imaging an image in front of a vehicle (an imaging range 350). The vehicle information acquisition device 320 sends an instruction to the imaging system 300 or the imaging device 310. With such a configuration, the accuracy of distance measurement may be further improved.

In the above description, an example has been described in which control is performed so as not to collide with other vehicles, but the present invention is also applicable to control of automatic driving following other vehicles, control of automatic driving so as not to go out of a lane, and the like. Further, the imaging system is not limited to a vehicle such as a host vehicle, and may be applied to, for example, a movable object (moving device) such as a ship, an aircraft, or an industrial robot. In addition, the present invention may be applied not only to a movable object but also to a wide variety of equipment such as an ITS (Intelligent Transport Systems).

### Fifth Embodiment

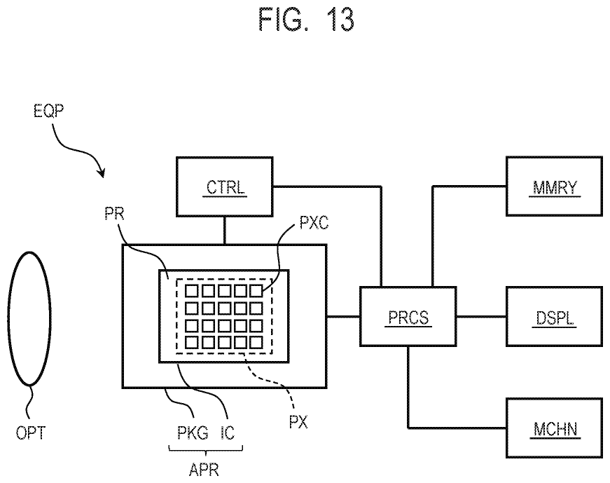

Equipment according to a fifth embodiment of the present invention will be described with reference to FIG. 13. FIG. 13 is a block diagram illustrating a schematic configuration of equipment according to the present embodiment.

FIG. 13 is a schematic diagram illustrating equipment EQP including the photoelectric conversion device APR. The photoelectric conversion device APR has the function of the photoelectric conversion device 100 described in the first or the second embodiment. All or a part of the photoelectric conversion device APR may be a semiconductor device IC. The photoelectric conversion device APR of this example may be used, for example, as an image sensor, an AF (Auto Focus) sensor, a photometry sensor, or a distance measurement sensor. The semiconductor device IC includes a pixel area PX in which pixel circuits PXC including photoelectric conversion units are arranged in a matrix. The semiconductor device IC may include a peripheral area PR around the pixel area PX. Circuits other than the pixel circuits may be arranged in the peripheral area PR.

The photoelectric conversion device APR may have a structure (chip stacked structure) in which a first semiconductor chip provided with the plurality of photoelectric conversion units and a second semiconductor chip provided with the peripheral circuits are stacked. Each peripheral circuit on the second semiconductor chip may be a column circuit corresponding to a pixel column of the first semiconductor chip. The peripheral circuits on the second semiconductor chip may be matrix circuits corresponding to the pixels or the pixel blocks of the first semiconductor chip. As a connection between the first semiconductor chip and the second semiconductor chip, a through electrode (TSV (Through Silicon Via)), an inter-chip interconnection by direct bonding of a conductor such as copper, a connection by micro bumps between chips, a connection by wire bonding, or the like may be adopted.

In addition to the semiconductor device IC, the photoelectric conversion device APR may include a package PKG that accommodates the semiconductor device IC. The package PKG may include a base body to which the semiconductor device IC is fixed, a lid body made of glass or the like facing the semiconductor device IC, and a connection member such as a bonding wire or a bump that connects a terminal provided on the base body to a terminal provided on the semiconductor device IC.

The equipment EQP may further comprise at least one of an optical device OPT, a control device CTRL, a processing device PRCS, a display device DSPL, a storage device MMRY, and a mechanical device MCHN. The optical device OPT corresponds to the photoelectric conversion device APR as a photoelectric conversion device, and is, for example, a lens, a shutter, or a mirror. The control device CTRL controls the photoelectric conversion device APR, and is, for example, a semiconductor device such as an ASIC. The processing device PRCS processes a signal output from the photoelectric conversion device APR, and constitutes an AFE (analog front end) or a DFE (digital front end). The processing unit PRCS is a semiconductor device such as a CPU (central processing unit) or an ASIC. The display device DSPL may be an EL (electroluminescent) display device or a liquid crystal display device which displays information (image) obtained by the photoelectric conversion device APR. The storage device MMRY may be a magnetic device or a semiconductor device that stores information (image) obtained by the photoelectric conversion device APR. The storage device MMRY may be a volatile memory such as an SRAM or a DRAM, or a nonvolatile memory such as a flash memory or a hard disk drive. The mechanical device MCHN includes a movable portion or a propulsion portion such as a motor or an engine. In the equipment EQP, a signal output from the photoelectric conversion device APR may be displayed on the display device DSPL, and is transmitted to the outside by a communication device (not illustrated) included in the equipment EQP. Therefore, it is preferable that the equipment EQP further includes a storage device MMRY and a processing device PRCS separately from the storage circuit unit and the arithmetic circuit unit included in the photoelectric conversion device APR.

The equipment EQP illustrated in FIG. 13 may be an electronic device such as an information terminal (for example, a smartphone or a wearable terminal) having a photographing function or a camera (for example, an interchangeable lens camera, a compact camera, a video camera, and a surveillance camera.). The mechanical device MCHN in the camera may drive components of the optical device OPT for zooming, focusing, and shutter operation. The equipment EQP may be a transportation device (movable object) such as a vehicle, a ship, or an airplane. The equipment EQP may be a medical device such as an endoscope or a CT scanner.

The mechanical device MCHN in the transport device may be used as a mobile device. The equipment EQP as a transport device is suitable for transporting the photoelectric conversion device APR, or for assisting and/or automating operation (manipulation) by an imaging function. The processing device PRCS for assisting and/or automating operation (manipulation) may perform processing for operating the mechanical device MCHN as a mobile device based on information obtained by the photoelectric conversion device APR.

The photoelectric conversion device APR according to the present embodiment may provide the designer, the manufacturer, the seller, the purchaser, and/or the user with high value. Therefore, when the photoelectric conversion device APR is mounted on the equipment EQP, the value of the equipment EQP may be increased. Therefore, in order to increase the value of the equipment EQP, it is advantageous to determine the mounting of the photoelectric conversion device APR of the present embodiment on the equipment EQP when the equipment EQP is manufactured and sold.

### Modified Embodiments

The present invention is not limited to the above-described embodiments, and various modifications are possible.

For example, an example in which some of the configurations of any of the embodiments are added to other embodiments or an example in which some of the configurations of any of the embodiments are substituted with some of the configurations of the other embodiments are also an embodiment of the present invention.

Further, in the above-described embodiment, the vertical output lines 16 in each column of the pixel regions 10 and 20 are configured by four output lines, but the number of output lines constituting the vertical output line 16 in each column is not limited to four, and may be two or more.

Further, in the above-described embodiment, the reset transistor M5 and the select transistor M7 are operated when the unused output line is driven in the null pixel 22, but the configuration of driving the unused output line by the null pixel 22 is not limited thereto. For example, only the select transistor M7 may be operated, or a transfer transistor similar to that of the unit pixel 12 may be provided in the null pixel 22 to be driven in the same manner as the unit pixel 12. By making the configuration of the null pixel 22 closer to the configuration of the unit pixel 12, the load of the vertical line may be made more uniform. The configuration of the null pixel 22 may be appropriately changed according to the effect of reducing the circuit area and image quality degradation for realizing this.

Further, in the above-described embodiment, the example in which the unused output line is driven by the null pixel 22 has been described, but it is also possible to configure such that the unused output line is driven by using a component other than the null pixel 22, for example, a light-shielded pixel (optical black pixel) in which a photoelectric conversion unit is shielded. It is also possible to provide a configuration in which a signal of a focus detection pixel, a signal of a failure detection pixel, or the like, which is different from a signal for image formation, may output to an unused output line.

The circuit configuration of the unit pixel 12 illustrated in FIG. 2 is an example, and may be appropriately changed. For example, the number of photoelectric conversion elements included in each unit pixel 12 may be one. The number of photoelectric conversion elements included in each unit pixel 12 may be three or more. In this case, a plurality of photoelectric conversion elements may share one node FD. Further, a plurality of photoelectric conversion elements may be pupil-division pixels sharing one microlens so that phase difference may be detected. The unit pixel 12 does not necessarily have to include the select transistor M4. The capacitance value of the node FD may be switchable.

The imaging systems described in the third and fourth embodiments are examples of imaging systems to which the photoelectric conversion device of the present invention may be applied, and imaging systems to which the photoelectric conversion device of the present invention may be applied are not limited to the configurations illustrated in FIG. 11 and FIG. 12A.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-121644, filed Jul. 29, 2022, which is hereby incorporated by reference herein in its entirety.

What is claimed is:

1. A photoelectric conversion device comprising:
a plurality of pixels arranged to form a plurality of rows and a plurality of columns, each of the plurality of pixels including a photoelectric conversion unit;
a plurality of output lines, at least two of the plurality of output lines being arranged in each of the plurality of columns, each of the plurality of output lines being connected to a pixel of a corresponding column;
a scanning circuit configured to sequentially select plural rows that are a part of the plurality of rows; and
a selection circuit that includes an input unit to which a control signal different from a control signal input to the scanning circuit is input and is configured to select a row that is the other part of the plurality of rows.

2. The photoelectric conversion device according to claim 1 further comprising a control circuit configured to control the scanning circuit and the selection circuit,
wherein the control circuit controls, in a period of outputting a signal of a first pixel of a first row among the plural rows of the part to a first output line among the plurality of output lines by selecting the first row by the scanning circuit, the selection circuit to select a second row of the other part to output a signal of a second pixel of the second row to a second output line arranged in a same column as the first output line.

3. The photoelectric conversion device according to claim 2, wherein the first output line and the second output line are adjacent to each other.

4. The photoelectric conversion device according to claim 2, wherein pixels arranged in the row of the other part are pixels that do not include the photoelectric conversion unit.

5. The photoelectric conversion device according to claim 3, wherein pixels arranged in the row of the other part are pixels that do not include the photoelectric conversion unit.

6. The photoelectric conversion device according to claim 2, wherein pixels arranged in the row of the other part are light-shielded pixels in which the photoelectric conversion unit is shielded from light.

7. The photoelectric conversion device according to claim 3, wherein pixels arranged in the row of the other part are light-shielded pixels in which the photoelectric conversion unit is shielded from light.

8. The photoelectric conversion device according to claim 4, wherein the signal output to the second output line is an N-signal output from the second pixel of the second row.

9. The photoelectric conversion device according to claim 5, wherein the signal output to the second output line is an N-signal output from the second pixel of the second row.

10. The photoelectric conversion device according to claim 2, wherein a use of the signal output to the first output line is different from a use of the signal output to the second output line.

11. The photoelectric conversion device according to claim 3, wherein a use of the signal output to the first output line is different from a use of the signal output to the second output line.

12. The photoelectric conversion device according to claim 1, wherein the control signal input to the selection circuit includes information on an output line from which a signal of a pixel of the plural rows of the part is not output among output lines arranged in a same column as an output line from which a signal from a pixel of the plural rows of the part is output.

13. The photoelectric conversion device according to claim 1, wherein the selection circuit is provided outside the scanning circuit.

14. The photoelectric conversion device according to claim 1, wherein the selection circuit is provided in the scanning circuit.

15. The photoelectric conversion device according to claim 1, wherein each of the pixels arranged in the plural rows of the part includes a plurality of photoelectric conversion units.

16. A method of driving a photoelectric conversion device including a plurality of pixels arranged to form a plurality of rows and a plurality of columns, wherein each of the plurality of pixels includes a photoelectric conversion unit, a plurality of output lines, wherein at least two of the plurality of output lines are arranged in each of the plurality of columns and each of the plurality of output lines is connected to a pixel of a corresponding column, a scanning circuit configured to sequentially select plural rows that are a part of the plurality of rows, and a selection circuit configured to select a row that is the other part of the plurality of rows, the method comprising:
selecting a first row among the part of the plurality rows by the scanning circuit, and
selecting, in a period of outputting a signal of a first pixel of the first row to a first output line among the plurality of output lines, a second row among the other part of the plurality of rows to output a signal of a second pixel of the second row to a second output line arranged in a same column as the first output line.

17. An imaging system comprising:
the photoelectric conversion device according to claim 1; and
a signal processing device configured to process a signal output from the photoelectric conversion device.

18. A movable object comprising:
the photoelectric conversion device according to claim 1; and
a distance information acquisition unit configured to acquire distance information to an object from a parallax image based on a signal from the photoelectric conversion device; and
a control unit configured to control the movable object based on the distance information.

19. Equipment comprising:
the photoelectric conversion device according to claim 1, and
at least one of
an optical device corresponding to the photoelectric conversion device,
a control device configured to control the photoelectric conversion device,
a processing device configured to process a signal output from the photoelectric conversion device,
a mechanical device that is controlled based on information obtained by the photoelectric conversion device,
a display device configured to display information obtained by the photoelectric conversion device, and
a storage device configured to store information obtained by the photoelectric conversion device.
